(19) United States
(12) Patent Application Publication
(10) Pub. No.: US 2024/0349332 A1
(43) Pub. Date: Oct. 17, 2024

(54) ACCESS METHOD AND APPARATUS, AND ACCESS CONTROL METHOD AND APPARATUS

(71) Applicant: BEIJING UNISOC COMMUNICATIONS TECHNOLOGY CO., LTD., Beijing (CN)

(72) Inventor: Miao WANG, Shanghai (CN)

(21) Appl. No.: 18/293,495

(22) PCT Filed: Jul. 27, 2022
(86) PCT No.: PCT/CN2022/108064

§ 371 Date: Jan. 30, 2024

(30) Foreign Application Priority Data
Jul. 30, 2021 (CN) 202110873639.0

(51) Int. Cl. H04W 74/08; H04W 72/0453; H04W 72/53

(52) U.S. Cl. CPC H04W 74/08; H04W 72/0453; H04W 72/53

(57) ABSTRACT

The present application disclosure provides an access method and apparatus, and an access control method and apparatus. The access method includes: receiving system information which includes access probability indication information, where the access probability indication information indicates access probabilities corresponding to different frequency bands in a same cell; and selecting a frequency band to access based on the access probabilities corresponding to the different frequency bands, and performing access.

### CROSS-REFERENCE TO RELATED APPLICATIONS

This is the U.S. national stage of application No. PCT/CN2022/108064, filed on Jul. 27, 2022. Priority under 35 U.S.C. § 119 (a) and 35 U.S.C. § 365 (b) is claimed from Chinese Application No. 202110873639.0, filed Jul. 30, 2021, the disclosure of which is also incorporated herein by reference.

### TECHNICAL FIELD

The present disclosure generally relates to the communication technology field, and more particularly, to an access method and apparatus, and an access control method and apparatus.

### BACKGROUND

When some operators use spectrum resources, the spectrum resources in certain frequency bands are very limited, especially in low frequency bands, which may only include spectrum of 5 Megabits (M) or 10 M. According to current 3rd Generation Partnership Project (3GPP) standards, different frequency bands need to correspond to different cells, and different cells need to periodically broadcast Synchronization Signal Block (SSB) and System Information Block (SIB), thereby causing a lot of overhead, and resulting in fewer actual available resources in the frequency bands. To solve this problem, a concept of Multi-Band Serving Cell (MB-SC) has been proposed, that is, a same cell includes multiple frequency bands. For example, a cell includes 700 M, 800 M and 900 M, where SSB and SIB are broadcast in a certain frequency band, but not broadcast in other frequency bands. Considering that there are existing terminals in some frequency bands, SSB and SIB can be broadcast in certain frequency bands and are not broadcast in other frequency bands.

### SUMMARY

Embodiments of the present disclosure provide an access method and apparatus, and an access control method and apparatus, which provides a solution for frequency band selection in an MB-SC scenario.

In an embodiment of the present disclosure, an access method is provided, including: receiving system information which includes access probability indication information, where the access probability indication information indicates access probabilities corresponding to different frequency bands in a same cell; and selecting a frequency band to access based on the access probabilities corresponding to the different frequency bands, and performing access.

In an embodiment of the present disclosure, an access control method is provided, including: determining access probability indication information, where the access probability indication information indicates access probabilities corresponding to different frequency bands in a same cell; and transmitting system information, where the system information includes the access probability indication information used for cell access.

In an embodiment of the present disclosure, a computer readable storage medium having computer instructions stored therein is provided, where when the computer instructions are executed by a processor, any one of the above methods is performed.

In an embodiment of the present disclosure, an access apparatus which includes a memory, and a processor is provided, where the memory has computer instructions stored therein, and when the processor executes the computer instructions, the above access method is performed.

In an embodiment of the present disclosure, an access control apparatus which includes a memory, and a processor is provided, where the memory has computer instructions stored therein, and when the processor executes the computer instructions, the above access control method is performed.

### BRIEF DESCRIPTION OF THE DRAWINGS

FIG. 1 is a flow chart of an access method according to an embodiment.

FIG. 2 is a block diagram of an access apparatus according to an embodiment.

FIG. 3 is a block diagram of an access control apparatus according to an embodiment.

FIG. 4 is a diagram of hardware structures of an access apparatus or an access control apparatus according to an embodiment.

### DETAILED DESCRIPTION

Communication systems applicable to embodiments of the present disclosure include but are not limited to Long Term Evolution (LTE) systems, 5th-generation (5G) systems, New Radio (NR) systems, and future evolution systems or a fusion system of various communications. The 5G system may be a non-standalone (NSA) 5G system or a standalone (SA) 5G system. The technical solutions of the present disclosure also may be applied to different network architectures, including but not limited to a relay network architecture, a dual-link architecture, and a vehicle-to-everything architecture.

The present disclosure mainly relates to communication between a UE and a network device.

The network device in the embodiments of the present disclosure may also be referred to as an access network device, such as a base station (also called a base station equipment), and is a device deployed in a Radio Access Network (RAN) to provide radio communication functions. For example, an equipment that provides a base station function in a 2G network includes a Base Transceiver Station (BTS) and a Base Station Controller (BSC). An equipment that provides the base station function in a 3G network includes a Node B. An equipment that provides the base station function in a 4G network includes an evolved Node B (eNB). In a Wireless Local Area Network (WLAN), an equipment that provides the base station function is an Access Point (AP). An equipment that provides the base station function in a 5G New Radio (NR) includes gNB and a continuously evolved Node B (ng-eNB), where gNB and the terminal use NR technology for communication, ng-eNB and the terminal use Evolved Universal Terrestrial Radio Access (E-UTRA) technology for communication, and both gNB and ng-eNB can be connected to a 5G core network. And the base station also refers to an equipment that provides the base station function in a new communication system in the future.

The base station controller in the embodiments of the present disclosure is a device for managing base stations, such as a Base Station Controller (BSC) in a 2G network, a Radio Network Controller (RNC) in a 3G network, or a device that controls and manages a base station in a new communication system in the future.

The network in the embodiments of the present disclosure refers to a communication network that provides communication services for terminals, including a base station of a radio access network, a base station controller of a radio access network, and a device on a core network side.

The UE in the embodiments of the present disclosure may refer to various forms of terminal device, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

To solve the technical problem, one of the most intuitive solutions is to configure different numbers of Random Access Occasions (RACH Occasions, ROs) for different frequency bands. As a UE randomly selects from multiple ROs corresponding to SSB, and different numbers of ROs are configured in different frequency bands, probabilities of the UE accessing different frequency bands are also different.

However, if an operator's bandwidth in a certain frequency band is quite small, such as only 5 M, the number of ROs that can be configured in this frequency band is very limited. When the load of this frequency band is low, it is difficult to increase the number of ROs in this frequency band to allow more UEs to access this frequency band. In addition, to allow existing terminals to access, frequency bands of existing terminals need to broadcast SSB and SIB. These frequency bands have relatively heavy loads. However, to meet access needs of the existing terminals, the ROs configured in these frequency bands cannot be too few. This may result in a larger number of UEs accessing these frequency bands with relatively heavy loads, which further causes heavier loads. From above, current solutions cannot reasonably control the access of UE, which reduces operation efficiency of the network.

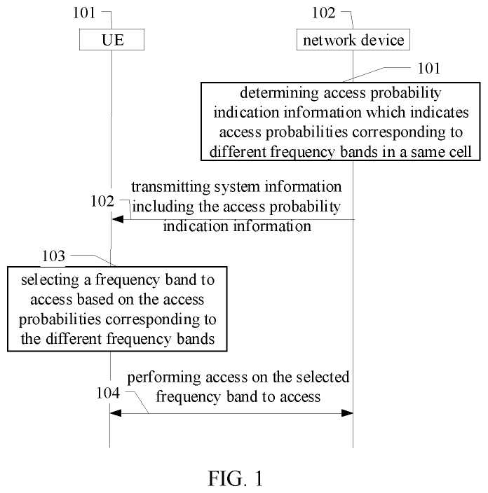

In the embodiments of the present disclosure, a method is provided, where the UE may receive system information including access probability indication information which indicates access probabilities corresponding to different frequency bands in a same cell, select a frequency band to access based on the access probabilities corresponding to the different frequency bands, and perform access, thereby providing a solution for frequency band selection in an MB-SC scenario. The method is an access method for a UE and is an access control method for a network device. Referring to FIG. 1, the method includes 101 to 102.

In 101, a network device 102 determines access probability indication information, where the access probability indication information indicates access probabilities corresponding to different frequency bands in a same cell.

In some embodiments, the network device may determine the access probability indication information based on a load of each frequency band or an access policy on the network side.

In 102, the network device 102 transmits system information, where the system information includes the access probability indication information used for cell access. Accordingly, the UE receives the system information.

Specifically, the system information may be a System Information Block (SIB), which is not limited in the embodiments of the present disclosure.

In some embodiments, the network device may select at least one frequency band among the different frequency bands in the current cell to transmit the system information. A specific implementation principle for selecting the frequency band can be configured according to an actual application scenario, which is not limited in the embodiments of the present disclosure.

The method shown in FIG. 1 further includes 103 and 104.

In S103, the UE 101 selects a frequency band to access based on the access probabilities corresponding to the different frequency bands.

In S104, the UE 101 performs access on the selected frequency band to access.

It should be noted that sequence numbers of steps in the embodiments do not represent a limitation on an execution order of the steps.

It could be understood that a specific access procedure of the UE accessing the network device and a core network may be referred to existing techniques and is not repeated here.

It could be understood that in specific implementation, the method may be implemented in a form of software program which runs in a processor integrated within a chip or chip module. Alternatively, the method may be implemented using a combination of software and hardware, which is not limited in the present disclosure.

The cell in the embodiments is an MB-SC cell with multiple frequency bands therein.

In some embodiments, the network device may configure and transmit the system information which carries the access probability indication information. The access probability indication information indicates the access probabilities corresponding to different frequency bands in the MB-SC cell. The access probabilities corresponding to the different frequency bands may be the same or different.

Therefore, the UE can learn the access probability corresponding to each frequency band in the MB-SC cell by receiving the system information. Further, in some embodiments, in 103, the UE may select the frequency band to access based on the access probability corresponding to each frequency band. The greater the access probability of the frequency band, the greater the probability that the UE accesses the frequency band. For example, the access probability corresponding to frequency band 1 is 0.9, then the probability of the UE accessing frequency band 1 is 0.9, and the probability of the UE accessing other frequency bands is 0.1.

In some embodiments, the access probability corresponding to the frequency band may represent a load of the frequency band. The greater the access probability corresponding to the frequency band, the lower the load of the frequency band. If performing an access procedure based on the access probability corresponding to the frequency band, the UE can access the frequency band with lower load with a greater probability.

In some embodiments, the access probability corresponding to the frequency band may represent the access policy on the network side. The greater the access probability corresponding to the frequency band, the more the network side expects the UE to access the frequency band. If performing the access procedure based on the access probability corresponding to the frequency band, the UE can access the frequency band that the network side expects the UE to access with a greater probability.

In the embodiments of the present disclosure, the UE may receive the system information including the access probability indication information which indicates the access probabilities corresponding to the different frequency bands in the same cell, select the frequency band to access based on the access probabilities corresponding to the different frequency bands, and perform access, thereby providing a solution for frequency band selection in the MB-SC scenario. When the access probability of each frequency band is determined based on the load on each frequency band or the access policy on the network side, by configuring the probability indication information, the UE is able to learn the access probability corresponding to each frequency band in the cell, that is, learn the load on each frequency band in the cell, or the access strategy on the network side, which allows the UE to access a better frequency band (a frequency band with a lower load) to meet data transmission requirements and improve operation efficiency of the network. In some embodiments, the access probability indication information may be implemented in any one of following manners 1 to 4.

In manner 1, the access probability indication information indicates values of the access probabilities corresponding to different frequency bands in the same cell.

In manner 1, the system information directly carries the value of the access probability corresponding to each frequency band.

In some embodiments, a possible value of the access probability corresponding to a frequency band may be preset or specified in a standard or determined through negotiation between the UE and the network device, which is not limited in the present disclosure.

For example, the possible values of the access probability corresponding to a frequency band may include 1, 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, 0.05, 0, etc. Before broadcasting the value of the access probability, the network device selects the value of the access probability corresponding to each frequency band from the above value range. A sum of the values of the access probabilities corresponding to the frequency bands is equal to 1.

For example, assume that the MB-SC cell includes band A, band B and band C. The network device may broadcast through SIB that the access probability corresponding to band A is 0.5, the access probability corresponding to band B is 0.2, and the access probability corresponding to band C is 0.3.

In manner 2, the access probability indication information indicates indexes of the access probabilities corresponding to the different frequency bands in the same cell, where the index of each of the access probabilities corresponds to a value of the access probability.

In manner 2, the system information carries the index of the access probability corresponding to each frequency band, and the index of the access probability has a corresponding relationship with the value of the access probability. The above corresponding relationship may be pre-agreed by a communication standard or may be sent to the UE by the network device in advance, so that the UE can determine the value of the access probability by searching in the corresponding relationship after receiving the index. That is, the UE determines the value of the access probability corresponding to each frequency band based on the index of the access probability and correspondence between the index and the value of the access probability.

For example, assume that the MB-SC cell includes band A, band B and band C. The access probability corresponding to band A is 0.5, the access probability corresponding to band B is 0.2, the access probability corresponding to band C is 0.3, the index corresponding to the value 0.5 of access probability is 0, the index corresponding to the value 0.3 of access probability is 1, and the index corresponding to the value 0.2 of access probability is 2. The network device broadcasts through SIB that the index corresponding to band A is 0, the index corresponding to band B is 2, and the index corresponding to band C is 1.

In manner 3, the access probability indication information indicates levels of different frequency bands in the same cell, and values of access probabilities corresponding to the levels, where each level corresponds to one or more frequency bands.

In manner 3, the system information carries the level of each frequency band and the value of the access probability corresponding to each level. A number N of the levels may be preset, for example, specified in a 3GPP standard.

Specifically, the level of the frequency band has a corresponding relationship with the value of the access probability. The above corresponding relationship may be pre-agreed by the 3GPP standard or may be sent to the UE by the network device in advance, so that the UE can determine the value of the access probability by searching in the corresponding relationship after receiving the level of the frequency band. That is, the UE determines the value of the access probability corresponding to each frequency band based on the level of the frequency band and the corresponding relationship between each level and value of the access probability.

In some embodiments, a possible value of the access probability corresponding to a level may be preset or specified in a standard or determined through negotiation between the UE and the network device, which is not limited in the present disclosure. For example, the possible values of the access probability corresponding to a level include 1, 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, 0.05, 0, etc. Before broadcasting the value of the access probability, the network device selects the value of the access probability corresponding to each level from the above value range.

For example, assume that the MB-SC cell includes band A, band B and band C. The network device broadcasts through SIB that band A corresponds to level 1, band B corresponds to level 2, band C corresponds to level 1, the access probability corresponding to level 1 is 80%, and the access probability corresponding to level 2 is 20%.

Compared with manners 1 and 2, in manner 3, the same level may correspond to multiple frequency bands. Therefore, there is no need to indicate the value of the access probability corresponding to each frequency band, that is, fewer bits are used to indicate the values of the access probabilities corresponding to the frequency bands. Accordingly, less signaling overhead is caused.

In manner 4, the access probability indication information indicates levels of the different frequency bands in the same cell, and values of access probabilities corresponding to (N−1) levels, where N is a number of the levels, a sum of the access probabilities corresponding to the N levels is 1, and each level corresponds to one or more frequency bands.

Different from manner 3 where the network device broadcasts the values of the access probabilities corresponding to the levels, in manner 4, the network device broadcasts the values of the access probabilities corresponding to (N−1) levels. Reasons are as follows. A sum of the access probabilities corresponding to N levels is 1, and thus after broadcasting the values of the access probabilities corresponding to (N−1) levels, the value of the access probability corresponding to level N can be obtained through calculation.

For example, N is 2, a base station broadcasts that the access probability corresponding to level 1 is 80%, thus, the access probability corresponding to level 2 is (1-80%=20%).

Compared with manner 3, manner 4 may further reduce signaling overhead.

In manners 3 and 4, the level of the frequency band may indicate a priority of the frequency band. In other words, for the MB-SC scenario, in the embodiment, different priorities are configured for different frequency bands in the same cell, and different priorities correspond to different random access probabilities. Before initiating random access, the UE determines the frequency band to access based on the priorities of the different frequency bands and their corresponding probabilities.

In some embodiments, the UE selects a frequency band to access based on the access probabilities corresponding to the different frequency bands and performs access in accordance with following processes.

The UE generates a random number within [0, 1], and compares the random number with an access threshold corresponding to each access frequency band in multiple access frequency bands. If the random number falls between the access threshold corresponding to a first frequency band and the access threshold corresponding to the second frequency band, the UE determines the second frequency band as the access frequency band and performs access, where the first frequency band is a frequency band in the multiple frequency bands, and the second frequency band follows the first frequency band and is adjacent to the first frequency band among the multiple frequency bands. The access threshold corresponding to one frequency band is a sum of the access probabilities corresponding to the frequency bands before the one frequency band among the multiple frequency bands and the access probability corresponding to the one frequency band.

For example, assume that the MB-SC cell includes band A, band B and band C. The network device broadcasts through SIB that the access probability corresponding to band A is 0.5, the access probability corresponding to band B is 0.2, and the access probability corresponding to band C is 0.3. The UE can determine that the access threshold corresponding to band A is 0.5, the access threshold corresponding to band B is 0.7, and the access threshold corresponding to band C is 1.

Before initiating random access, the UE first generates a random number evenly distributed in [0, 1]. When the random number is smaller than 0.5, the UE accesses through a random RO in band A, when the random number is greater than or equal to 0.5 and smaller than 0.7, the UE accesses through a random RO in band B, otherwise, the UE accesses through a random RO in band C.

For another example, assume that the network device broadcasts that band A is level 1, band B is level 2, band Cis level 1, the access probability corresponding to level 1 is 80%, and the access probability corresponding to level 2 is 20%. Then the UE can determine that the access threshold corresponding to band A and band C is 0.8, and the access threshold corresponding to band B is 1.

Before initiating random access, the UE first generates a random number evenly distributed in [0, 1]. When the random number is smaller than 80%, the UE accesses through a random RO in band A or band C, otherwise, the UE accesses through a random RO in band B.

The network device in the embodiments of the present disclosure may adjust the frequency band in which the UE initiates random access based on the loads of different frequency bands or the network policy.

Compared with the existing techniques, the embodiments of the present disclosure do not rely on bandwidth of frequency bands when configuring the access probabilities for the frequency bands, which meets both access requirements of frequency bands with low bandwidth, and access requirements of frequency bands with existing terminals, ensures data transmission efficiency, and improves operation efficiency of the network.

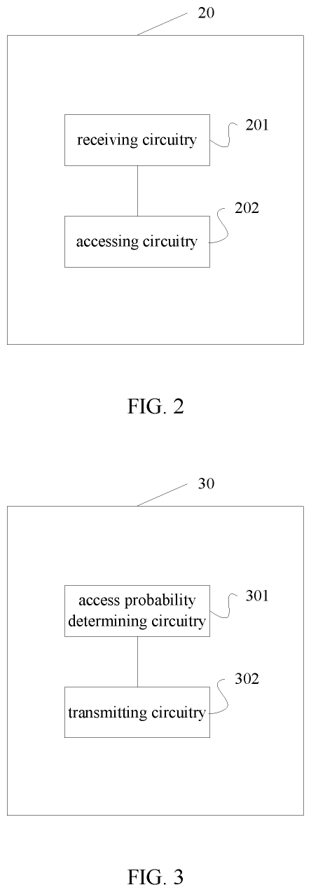

Referring to FIG. 2, FIG. 2 is a block diagram of an access apparatus 20 according to an embodiment. The access apparatus 20 includes: a receiving circuitry 201 configured to receive system information which includes access probability indication information, where the access probability indication information indicates access probabilities corresponding to different frequency bands in a same cell; and an accessing circuitry 202 configured to: select a frequency band to access based on the access probabilities corresponding to the different frequency bands, and perform access.

In some embodiments, the access apparatus 20 may correspond to a chip with an access function in a UE, such as a System-On-Chip (SOC) or a baseband chip, or to a chip module including a chip with an access function in the UE, or to a chip module including a chip with a data processing function, or to the UE.

Referring to FIG. 3, FIG. 3 is a block diagram of an access control apparatus 30 according to an embodiment. The access control apparatus 30 includes: an access probability determining circuitry 301 configured to determine access probability indication information, where the access probability indication information indicates access probabilities corresponding to different frequency bands in a same cell; and a transmitting circuitry 302 configured to transmit system information, where the system information includes the access probability indication information used for cell access.

In some embodiments, the access control apparatus 30 may correspond to a chip with an access function in a network device, such as an SOC or a baseband chip, or to a chip module including a chip with an access function in the network device, or to a chip module including a chip with a data processing function, or to the network device.

More details of the access apparatus 20 or the access control apparatus 30 can be referred to related descriptions in FIG. 1 and are not repeated here.

Each module/unit of each apparatus and product described in the above embodiments may be a software module/unit or a hardware module/unit or may be a software module/unit in part, and a hardware module/unit in part. For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a computer readable storage medium having computer instructions stored therein is provided, where when the computer instructions are executed, the method as shown in FIG. 1 is performed. In some embodiments, the storage medium may include a ROM, a RAM, a magnetic disk or an optical disk. In some embodiments, the storage medium may include a non-volatile or a non-transitory memory.

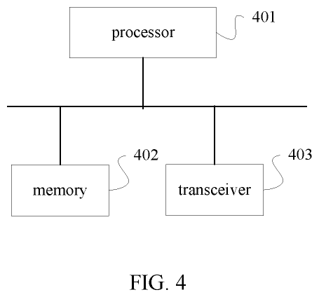

Referring to FIG. 4, FIG. 4 is a diagram of hardware structures of an access apparatus or an access control apparatus according to an embodiment. The apparatus includes a processor 401, a memory 402 and a transceiver 403.

The processor 401 may be a general Central Processing Unit (CPU), a microprocessor, an Application-Specific Integrated Circuit (ASIC), or one or more integrated circuits used to control execution of a program of the present application. The processor 401 may include multiple CPUs and may be a single-CPU processor or a multi-CPU processor. The processor here may refer to one or more devices, circuits or processing cores for processing data (e.g., computer program instructions).

The memory 402 may be ROM or other types of static storage devices that can store static information and instructions, RAM or other types of dynamic storage devices that can store information and instructions, Electrically Erasable Programmable Read-Only Memory (EEPROM), Compact Disc-Read Only Memory (CD-ROM) or other optical disc storage, optical disk storage (including compressed optical discs, laser discs, optical discs, digital versatile discs, Blu-ray discs, etc.), magnetic disk storage media or other magnetic storage devices, or any other medium that can be used to carry or store desired program codes in the form of instructions or data structures and can be accessed by a computer, which is not limited in the embodiments of the present disclosure. The memory 402 may exist independently (in this case, the memory 402 may be located outside the device or within the device) or may be integrated with the processor 401. The memory 402 may include computer program codes. The processor 401 is used to execute the computer program codes stored in the memory 402, thereby implementing the method provided in the embodiments of the present disclosure.

The processor 401, the memory 402 and the transceiver 403 are coupled through a bus. The transceiver 403 is used to communicate with other devices or communication networks. Optionally, the transceiver 403 may include a transmitter and a receiver. A device used to implement a receiving function in the transceiver 403 can be regarded as a receiver which is used to perform receiving steps in the embodiments of the present disclosure. A device used to implement a transmitting function in the transceiver 403 can be regarded as a transmitter which is used to perform transmitting steps in the embodiments of the present disclosure.

When the diagram shown in FIG. 4 is used to illustrate a structure of the UE (i.e., the access apparatus) involved in the above embodiments, the processor 401 is configured to control and manage actions of the UE. For example, the processor 401 is configured to support the UE to perform 102, 103 and 104 in FIG. 1, and/or actions performed by the UE in other procedures described in the embodiments of the present disclosure. The processor 401 may communicate with other network entities through the transceiver 403, for example, with the network device described above. The memory 402 is configured to store program codes and data of the UE. When the processor runs the computer program, the transceiver 403 is controlled to receive system information.

When the diagram shown in FIG. 4 is used to illustrate a structure of the network device (i.e., the access control apparatus) involved in the above embodiments, the processor 401 is configured to control and manage actions of the network device. For example, the processor 401 is configured to support the network device to perform 101, 102 and 104 in FIG. 1, and/or actions performed by the network device in other procedures described in the embodiments of the present disclosure. The processor 401 may communicate with other network entities through the transceiver 403, for example, with the UE described above. The memory 402 is configured to store program codes and data of network devices. When the processor runs the computer program, the transceiver 403 is controlled to transmit system information.

The “plurality” in the embodiments of the present disclosure refers to two or more.

The descriptions of the first, second, etc. in the embodiments of the present disclosure are merely for illustrating and differentiating the objects, and do not represent the order or the particular limitation of the number of devices in the embodiments of the present disclosure, which do not constitute any limitation to the embodiments of the present disclosure.

The “connection” in the embodiments of the present disclosure refers to various connection ways such as direct connection or indirect connection to realize communication between devices, which is not limited in the embodiments of the present disclosure.

The above embodiments may be implemented in whole or in part by software, hardware, firmware or any combination thereof. When implemented in software, the above embodiments may be implemented in whole or in part in the form of a computer program product. The computer program product includes one or more computer instructions or computer programs. The procedures or functions according to the embodiments of the present disclosure are wholly or partially generated when the computer instructions or the computer programs are loaded or executed on a computer. The computer may be a general-purpose computer, a special purpose computer, a computer network, or other programmable device. The computer instructions may be stored in a computer readable storage medium or transmitted from one computer readable storage medium to another computer readable storage medium, for example, the computer instructions may be transmitted from one website, computer, server or data center to another website, computer, server or data center by wire (e.g., infrared, wireless, microwave and etc.).

It should be understood that, in the various embodiments of the present disclosure, sequence numbers of the above-mentioned processes do not represent an execution sequence, and the execution sequence of each process should be determined by its function and inherent logic, which does not limit an implementation process of the embodiments of the present disclosure.

In the above embodiments of the present disclosure, it should be understood that the disclosed method, device and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. Further, the shown or discussed mutual coupling or direct coupling or communication connection may be an indirect coupling or communication connection via some interfaces, devices or units, and may be in an electrical, mechanical or other form.

The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

The integrated units implemented in the form of the software functional unit may be stored in a computer readable storage medium. The software functional unit is stored in a storage medium and includes several instructions for causing a computer device (a personal computer, a server or a network device) to execute some steps of the methods in the embodiments of the present disclosure.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. An access method, comprising:
receiving system information which comprises access probability indication information, wherein the access probability indication information indicates access probabilities corresponding to different frequency bands in a same cell; and
selecting a frequency band to access based on the access probabilities corresponding to the different frequency bands and performing access.

2. The method according to claim 1, wherein the access probability indication information indicates values of access probabilities corresponding to the different frequency bands in the same cell.

3. The method according to claim 1, wherein the access probability indication information indicates indexes of access probabilities corresponding to the different frequency bands in the same cell, and the index of each of the access probabilities corresponds to a value of the access probability.

4. The method according to claim 1, wherein the access probability indication information indicates levels of the different frequency bands in the same cell, and values of access probabilities corresponding to the levels, wherein each level corresponds to one or more frequency bands.

5. The method according to claim 1, wherein the access probability indication information indicates levels of the different frequency bands in the same cell, and values of access probabilities corresponding to (N−1) levels, wherein N is a number of the levels, a sum of the access probabilities corresponding to the N levels is 1, and each level corresponds to one or more frequency bands.

6. An access control method, comprising:
determining access probability indication information, wherein the access probability indication information indicates access probabilities corresponding to different frequency bands in a same cell; and
transmitting system information, wherein the system information comprises the access probability indication information used for cell access.

7. The method according to claim 6, wherein the access probability indication information indicates values of access probabilities corresponding to the different frequency bands in the same cell.

8. The method according to claim 6, wherein the access probability indication information indicates indexes of access probabilities corresponding to the different frequency bands in the same cell, and the index of each of the access probabilities corresponds to a value of the access probability.

9. The method according to claim 6, wherein the access probability indication information indicates levels of the different frequency bands in the same cell, and values of access probabilities corresponding to the levels, wherein each level corresponds to one or more frequency bands.

10. The method according to claim 6, wherein the access probability indication information indicates levels of the different frequency bands in the same cell, and values of access probabilities corresponding to (N−1) levels, wherein N is a number of the levels, a sum of the access probabilities corresponding to the N levels is 1, and each level corresponds to one or more frequency bands.

11. (canceled)

12. (canceled)

13. A non-transitory computer readable storage medium storing one or more programs, the one or more programs comprising computer instructions, which, when executed by a processor, cause the processor to perform the method of claim 1.

14. An access apparatus, comprising a memory and a processor, wherein the memory stores one or more programs, the one or more programs comprising computer instructions, which, when executed by the processor, cause the processor to:
receive system information which comprises access probability indication information, wherein the access probability indication information indicates access probabilities corresponding to different frequency bands in a same cell; and
select a frequency band to access based on the access probabilities corresponding to the different frequency bands, and perform access.

15. An access control apparatus, comprising a memory and a processor, wherein the memory stores one or more programs, the one or more programs comprising computer instructions, which, when executed by the processor, cause the processor to perform the method of claim 6.

16. A non-transitory computer readable storage medium storing one or more programs, the one or more programs comprising computer instructions, which, when executed by a processor, cause the processor to perform the method of claim 6.

17. The apparatus according to claim 14, wherein the access probability indication information indicates values of access probabilities corresponding to the different frequency bands in the same cell.

18. The apparatus according to claim 14, wherein the access probability indication information indicates indexes of access probabilities corresponding to the different frequency bands in the same cell, and the index of each of the access probabilities corresponds to a value of the access probability.

19. The apparatus according to claim 14, wherein the access probability indication information indicates levels of the different frequency bands in the same cell, and values of access probabilities corresponding to the levels, wherein each level corresponds to one or more frequency bands.

20. The apparatus according to claim 14, wherein the access probability indication information indicates levels of the different frequency bands in the same cell, and values of access probabilities corresponding to (N−1) levels, wherein N is a number of the levels, a sum of the access probabilities corresponding to the N levels is 1, and each level corresponds to one or more frequency bands.
